(19) United States
(12) Patent Application Publication
(10) Pub. No.: US 2025/0033503 A1
(43) Pub. Date: Jan. 30, 2025

(54) APPARATUS AND METHODS FOR A PORTABLE VEHICLE CHARGER

(71) Applicant: James Victor Morse, Orange, CA (US)

(72) Inventor: James Victor Morse, Orange, CA (US)

(21) Appl. No.: 18/227,259

(22) Filed: Jul. 27, 2023

(51) Int. Cl. B60L 53/31; H02J 3/46; H02J 7/00

(52) U.S. Cl. CPC B60L 53/31; H02J 3/46; H02J 7/0042

(57) ABSTRACT

An apparatus and methods are provided for a portable vehicle charger that allows existing Level 1, 2 and 3 vehicle chargers to be powered by multiple sources, such as a conventional grid, fuel generators, or battery generators, in remote or temporary locations. The portable vehicle charger receives single-phase or three-phase 240V power by way of Camlock inputs. The power is distributed to various power outlets through corresponding circuit breakers. The portable vehicle charger includes one or two primary Level 2 or 3 chargers, each protected by an individual circuit breaker. Two 14-50R power outlets are included and powered by way of 50 A circuit breakers for Level 2 plug-in chargers. Six 5-20R Edison power outlets are also included and powered by way of 20 A circuit breakers for Level 1 vehicle chargers or other battery charging needs. The portable vehicle charger is configured for rugged and outdoor use by way of weatherproofing.

### FIELD

Embodiments of the present disclosure generally relate to powered vehicles. More specifically, embodiments of the disclosure relate to an apparatus and methods for a portable vehicle charger for recharging multiple electric vehicles.

### BACKGROUND

Electrically powered vehicles generally solve problems associated with gasoline-powered vehicles, such as environmental pollution, noise and depletion of crude oil reserves due to the increasing use of gasoline-powered vehicles. As such, electrically powered vehicles are gaining in popularity and their use is becoming increasingly widespread. Unfortunately, a fast-charge infrastructure is failing to meet the increasing demands posed by an ever-increasing number of electric vehicles on the roads. For example, establishing a stationary fast-charging station tends to be a lengthy process. In many instances, acquiring the necessary permits to start construction of a fast-charging site can take up to two years.

Given the increasing prevalence of electric vehicles of all types, there is a continuing interest in providing a fast-charging infrastructure that is capable of meeting the demands of a growing national fleet of electrically powered vehicles.

### SUMMARY

An apparatus and methods are provided for a portable vehicle charger that allows existing Level 1, 2 and 3 vehicle chargers to be powered by multiple sources, such as a conventional grid, fuel generators, or battery generators, in remote or temporary locations. The portable vehicle charger receives single-phase or three-phase 240V power by way of Camlock inputs. The power is distributed to various power outlets through corresponding circuit breakers. The portable vehicle charger includes one or two primary Level 2 or 3 chargers, each protected by an individual circuit breaker. Two 14-50R power outlets are included and powered by way of 50 A circuit breakers for Level 2 plug-in chargers. Six 5-20R Edison power outlets are also included and powered by way of 20 A circuit breakers for Level 1 vehicle chargers or other battery charging needs. The portable vehicle charger is configured for rugged and outdoor use by way of weatherproofing.

In an exemplary embodiment, a portable vehicle charger comprises: a housing supported by a chassis; one or more power inlets coupled with the housing; one or more power outlets coupled with the housing; one or more circuit breakers disposed in the housing; and one or more primary vehicle chargers mounted onto the chassis.

In another exemplary embodiment, the chassis includes rear wheels, a handle, and feet for moving the portable vehicle charger and orienting the portable vehicle charger in an upright disposition. In another exemplary embodiment, the housing is configured for rugged and outdoor use by way of weatherproofing. In another exemplary embodiment, the housing include mounts that enable installation of a weather cover to protect the one or more circuit breakers and from the elements. In another exemplary embodiment, the housing is configured to receive a cover to protect each of the one or more power outlets from damage due to water, dirt, and environmental exposure.

In another exemplary embodiment, the one or more power outlets comprise one or more 5-20R Edison outlets. In another exemplary embodiment, the one or more 5-20R Edison outlets includes six 5-20R Edison outlets. In another exemplary embodiment, each of the one or more circuit breakers includes a 20 A circuit breaker for each of the six 5-20R Edison outlets. In another exemplary embodiment, each of the 20 A circuit breakers is configured for Level 1 vehicle chargers or other battery charging needs.

In another exemplary embodiment, the one or more power outlets comprises one or more 14-50R outlets. In another exemplary embodiment, the one or more 14-50R outlets includes two 14-50R outlets. In another exemplary embodiment, each of the one or more circuit breakers includes a 50 A circuit breaker for each of the two 14-50R outlets. In another exemplary embodiment, each of the 50 A circuit breakers is configured for Level 2 plug-in chargers.

In another exemplary embodiment, the portable vehicle charger is configured to receive electric power from a variety of different power supplies. In another exemplary embodiment, the one or more power inlets includes one or more Camlock inputs. In another exemplary embodiment, the one or more Camlock inputs comprises five Camlock inputs. In another exemplary embodiment, the one or more Camlock inputs are configured to receive single-phase or three-phase 240V power.

In another exemplary embodiment, each of the one or more primary vehicle chargers comprises a Level 2 or Level 3 single-phase charger. In another exemplary embodiment, each of the one or more primary vehicle chargers comprises a 3-phase charger. In another exemplary embodiment, each of the one or more primary vehicle chargers is protected by one or the one or more circuit breakers.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 illustrates a schematic diagram of an exemplary embodiment of a portable vehicle charger servicing multiple electric vehicles, according to the present disclosure;

FIG. 2 illustrates an isometric view of an exemplary embodiment of a portable vehicle charger in accordance with the present disclosure;

FIG. 3 illustrates a side view of an exemplary embodiment of a portable vehicle charger, according to the present disclosure;

FIG. 4 illustrates a front view of an exemplary embodiment of a portable vehicle charger in accordance with the present disclosure; and

FIG. 5 illustrates a back view of an exemplary embodiment of a portable vehicle charger, according to the present disclosure.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the portable vehicle charger and methods disclosed herein may be practiced without these specific details. In other instances, specific numeric references such as “first charger,” may be made. However, the specific numeric reference should not be interpreted as a literal sequential order but rather interpreted that the “first charger” is different than a “second charger.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

Electrically powered vehicles generally solve problems associated with gasoline-powered vehicles, such as environmental pollution, noise and depletion of crude oil reserves due to the increasing use of gasoline-powered vehicles. As such, electrically powered vehicles are gaining in popularity and their use is becoming increasingly widespread. Unfortunately, a fast-charge infrastructure is failing to meet the increasing demands posed by an ever-increasing number of electric vehicles on the roads. Given the increasing prevalence of electric vehicles of all types, there is a continuing interest in providing a fast-charging infrastructure that is capable of meeting the demands of a growing national fleet of electrically powered vehicles. Embodiments disclosed herein provide a portable vehicle charger that can be implemented more quickly than stationary charging stations that require a lengthy permitting process.

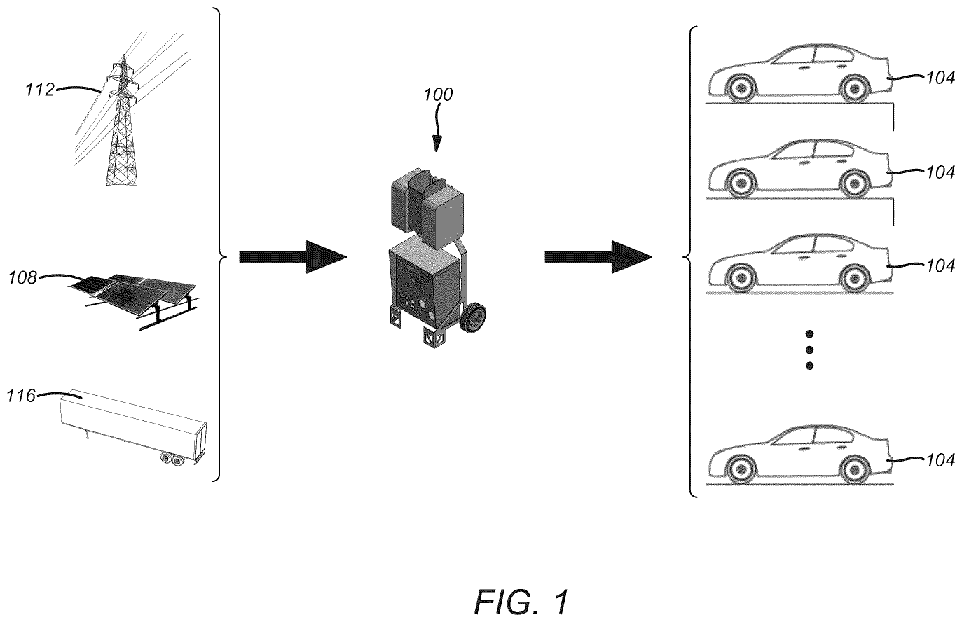

FIG. 1 illustrates a schematic diagram of an exemplary embodiment of a portable vehicle charger 100 servicing multiple electrically powered vehicles 104, according to the present disclosure. The portable vehicle charger 100 is configured to receive electric power from a variety of different power supplies and distribute the electric power to charge batteries onboard each of the electrically powered vehicle 104. As shown in FIG. 1, the power supplies may comprise a solar array 108, an electric grid 112, as well as a trailer 116 containing fuel or electric generators or previously charged battery arrays, and the like.

It is contemplated that the portable vehicle charger 100 may be used to distribute electric power to any number of electric vehicles 104 simultaneously. Further, the electrically powered vehicles 104 are not limited to automobiles, as illustrated in FIG. 1, but rather the portable vehicle charger 100 can be used to charge any of various types of electrically powered vehicles, such as watercraft, aircraft, motorcycles, electrically powered bicycles, scooters, and the like, without limitation.

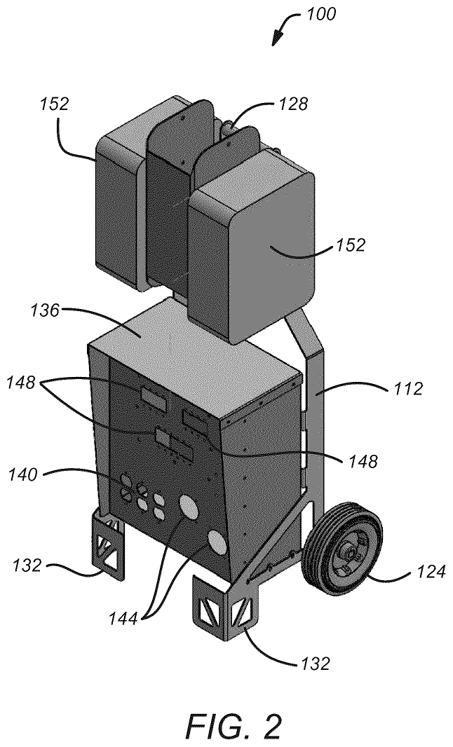

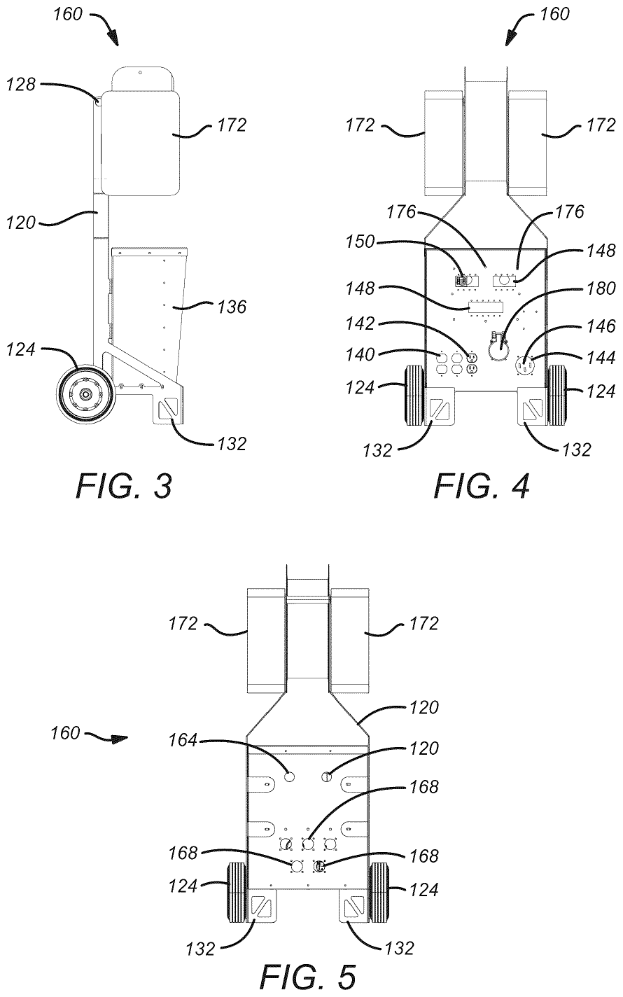

FIG. 2 illustrates an exemplary embodiment of a portable vehicle charger 100 in accordance with the present disclosure. The portable vehicle charger 100 comprises a chassis 120 that resembles a dolly having a pair of rear wheels 124 and an upper handle 128 for moving the charger 100. As will be appreciated, during moving the portable vehicle charger 100, a practitioner may use the handle 128 to lean the portable vehicle charger 100 backwards onto the rear wheels 124 and then roll the portable vehicle charger 100 from one location to another location. The chassis 120 includes front feet 132 opposite of the rear wheels 124 that are configured to support the portable vehicle charger 100 in an upright orientation, as shown in FIG. 3.

With continuing reference to FIG. 2, the portable vehicle charger 100 includes a housing 136 that is supported by the chassis 120. The housing 136 is configured to contain various power inlets, power outlets, and circuit breakers for distributing electric power as needed. In the illustrated embodiment of FIG. 2, the housing 136 includes six 5-20R Edison outlet openings 140, two 14-50R outlet openings 144, and three breaker openings 148 for holding multiple circuit breakers. It should be borne in mind, however, that the portable vehicle charger 100 is not limited to the number of outlet openings 140, 144 and breaker openings 148 shown in FIG. 2, but rather the portable vehicle charger 100 can include any desired number of outlet openings 140, 144 and breaker openings 148 as can be disposed in the housing 136.

As further shown in FIG. 2, the portable vehicle charger 100 includes primary vehicle chargers 152. The primary vehicle chargers 152 can be Level 2 or Level 3 single-phase chargers, or the primary vehicle chargers 152 can be 3-phase chargers, without limitation. It is contemplated that electric power to the primary vehicle chargers 152 is routed through corresponding circuit breakers that can be installed into any of the breaker openings 148 disposed in the housing 136.

FIGS. 3-5 illustrate an exemplary embodiment of a portable vehicle charger 160, according to the present disclosure. The portable vehicle charger 160 is substantially similar to the portable vehicle charger 10 of FIG. 2. As such, the portable vehicle charger 160 includes a chassis 120 having rear wheels 124, a handle 128, and feet 132 for moving the portable vehicle charger 160 and orienting the portable vehicle charger 160 in an upright disposition as shown in FIG. 3. As described hereinabove with respect to FIG. 2, during moving the portable vehicle charger 160, the practitioner may use the handle 128 to lean the portable vehicle charger 160 backwards onto the rear wheels 124 and then roll the portable vehicle charger 160 from one location to another location. The front feet 132 are configured to support the portable vehicle charger 100 in the upright disposition shown in FIG. 3.

As best shown in FIG. 4-5, the portable vehicle charger 160 includes a housing 136 that is supported by the chassis 120. Housing 136 is configured to contain various power inlets, power outlets, and circuit breakers for distributing electric power as needed. As shown in FIG. 4, the housing 136 includes six 5-20R Edison outlet openings 140, two 14-50R outlet openings 144, and three breaker openings 148 for holding multiple circuit breakers. For exemplary purposes, two 5-20R Edison outlets 142 are shown installed into openings 140, two 14-50R outlets 146 are shown installed into openings 144, and two circuit breakers 150 are shown installed into opening 148. It should be understood that the portable vehicle charger 160 is not limited to the number of outlet openings 140, 144 and breaker openings 148 shown in the illustrated embodiments, but rather the portable vehicle charger 160 can include any desired number of outlet openings 140, 144 and breaker openings 148 as space on the housing 136 will allow.

As shown in FIG. 5, the housing 136 includes two power supply inlet openings 164 and five Camlock input openings 168. The portable vehicle charger 160 is configured to receive single-phase or three-phase 240V power by way of Camlock inputs that may be installed into the openings 168. As mentioned in connection with FIG. 1, electric power may be received from a variety of different power supplies, such as, by way of nonlimiting example, a solar array 108, an electric grid 112, as well as a trailer 116 containing fuel or electric generators or previously charged battery arrays, and the like.

The electric power received by way of the power supply inlet and Camlock input may then be distributed to the above-discussed outlets through corresponding circuit breakers 150. For example, the portable vehicle charger 160 can include one or two primary vehicle chargers 172. Each of the primary vehicle chargers 172 can be Level 2 or Level 3 single-phase chargers, or the primary vehicle chargers 172 can be 3-phase chargers, without limitation. As will be appreciated, each of the primary vehicle chargers 172 may be protected by a corresponding circuit breaker 150, as described herein. Further, each of the two 14-50R outlets 146 may be powered by way of a 50 A circuit breaker 150 for Level 2 plug-in chargers. Each of the six 20 A Edison outlets 142 may be powered by way of a 20 A circuit breaker 150 for Level 1 vehicle chargers or other battery charging needs.

In some embodiments, the portable vehicle charger 160 is configured for rugged and outdoor use by way of weatherproofing. For example, as shown in FIG. 4, the housing 136 can include mounts 176 that enable installation of a weather cover to protect circuit breakers 150 and from the elements. Further, a cover 180 may installed onto the housing 136 to protect each of the 14-50R outlets 146 from the weather. It is contemplated that any of various other devices or mechanisms can be incorporated into the portable vehicle charger 160, without limitation, to protect the outlets and circuit breakers from damage due to water, dirt, and environmental exposure.

While the portable vehicle charger and methods have been described in terms of particular variations and illustrative figures, those of ordinary skill in the art will recognize that the portable vehicle charger is not limited to the variations or figures described. In addition, where methods and steps described above indicate certain events occurring in certain order, those of ordinary skill in the art will recognize that the ordering of certain steps may be modified and that such modifications are in accordance with the variations of the portable vehicle charger. Additionally, certain of the steps may be performed concurrently in a parallel process, when possible, as well as performed sequentially as described above. To the extent there are variations of the portable vehicle charger, which are within the spirit of the disclosure or equivalent to the portable vehicle charger found in the claims, it is the intent that this patent will cover those variations as well. Therefore, the present disclosure is to be understood as not limited by the specific embodiments described herein, but only by scope of the appended claims.

What is claimed is:

1. A portable vehicle charger, comprising:
a housing supported by a chassis;
one or more power inlets coupled with the housing;
one or more power outlets coupled with the housing;
one or more circuit breakers disposed in the housing; and
one or more primary vehicle chargers mounted onto the chassis.

2. The portable vehicle charger of claim 1, wherein the chassis includes rear wheels, a handle, and feet for moving the portable vehicle charger and orienting the portable vehicle charger in an upright disposition.

3. The portable vehicle charger of claim 1, wherein the housing is configured for rugged and outdoor use by way of weatherproofing.

4. The portable vehicle charger of claim 3, wherein the housing include mounts that enable installation of a weather cover to protect the one or more circuit breakers and from the elements.

5. The portable vehicle charger of claim 4, wherein the housing is configured to receive a cover to protect each of the one or more power outlets from damage due to water, dirt, and environmental exposure.

6. The portable vehicle charger of claim 1, wherein the one or more power outlets comprise one or more 5-20R Edison outlets.

7. The portable vehicle charger of claim 6, wherein the one or more 5-20R Edison outlets includes six 5-20R Edison outlets.

8. The portable vehicle charger of claim 7, wherein each of the one or more circuit breakers includes a 20 A circuit breaker for each of the six 5-20R Edison outlets.

9. The portable vehicle charger of claim 8, wherein each of the 20 A circuit breakers is configured for Level 1 vehicle chargers or other battery charging needs.

10. The portable vehicle charger of claim 1, wherein the one or more power outlets comprises one or more 14-50R outlets.

11. The portable vehicle charger of claim 10, wherein the one or more 14-50R outlets includes two 14-50R outlets.

12. The portable vehicle charger of claim 11, wherein each of the one or more circuit breakers includes a 50 A circuit breaker for each of the two 14-50R outlets.

13. The portable vehicle charger of claim 12, wherein each of the 50 A circuit breakers is configured for Level 2 plug-in chargers.

14. The portable vehicle charger of claim 1, wherein the portable vehicle charger is configured to receive electric power from a variety of different power supplies.

15. The portable vehicle charger of claim 1, wherein the one or more power inlets includes one or more Camlock inputs.

16. The portable vehicle charger of claim 15, wherein the one or more Camlock inputs comprises five Camlock inputs.

17. The portable vehicle charger of claim 16, wherein the one or more Camlock inputs are configured to receive single-phase or three-phase 240V power.

18. The portable vehicle charger of claim 1, wherein each of the one or more primary vehicle chargers comprises a Level 2 or Level 3 single-phase charger.

19. The portable vehicle charger of claim 1, wherein each of the one or more primary vehicle chargers comprises a 3-phase charger.

20. The portable vehicle charger of claim 1, wherein each of the one or more primary vehicle chargers is protected by one or the one or more circuit breakers.
